(19) United States
(12) Patent Application Publication
(10) Pub. No.: US 2016/0201831 A1
(43) Pub. Date: Jul. 14, 2016

(54) PIPE REPAIR SYSTEM

(71) Applicant: Kenneth Pinnell, Burbank, CA (US)

(72) Inventor: Kenneth Pinnell, Burbank, CA (US)

(21) Appl. No.: 14/592,905

(22) Filed: Jan. 9, 2015

(51) Int. Cl. F16L 27/11; F16L 27/12; F16L 27/10; F16L 13/10; F16L 21/00

(52) U.S. Cl. CPC F16L 27/11; F16L 13/103; F16L 21/002; F16L 27/1017; F16L 27/12

(57) ABSTRACT

A pipe repair system for repairing a ruptured pipe includes a pipe that is broken to define a first end of the pipe and a second end of the pipe. The pipe transfers a fluid. A tube is positioned to extend across the break in the pipe and fluidly join the first end to the second end. The tube prevents the fluid from escaping the pipe. The tube has an adjustable length to extend across the break in the pipe.

### BACKGROUND OF THE DISCLOSURE

### Field of the Disclosure

The disclosure relates to pipe repair devices and more particularly pertains to a new pipe repair device for repairing a ruptured pipe.

### SUMMARY OF THE DISCLOSURE

An embodiment of the disclosure meets the needs presented above by generally comprising a pipe that is broken to define a first end of the pipe and a second end of the pipe. The pipe transfers a fluid. A tube is positioned to extend across the break in the pipe and fluidly join the first end to the second end. The tube prevents the fluid from escaping the pipe. The tube has an adjustable length to extend across the break in the pipe.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a pipe repair system according to an embodiment of the disclosure.

FIG. 2 is a right side view of an embodiment of the disclosure.

FIG. 3 is a left side in-use view of an embodiment of the disclosure in an uncoupled condition

FIG. 4 is a left side in-use view of an embodiment of the disclosure in a coupled condition.

### DESCRIPTION OF THE PREFERRED EMBODIMENT

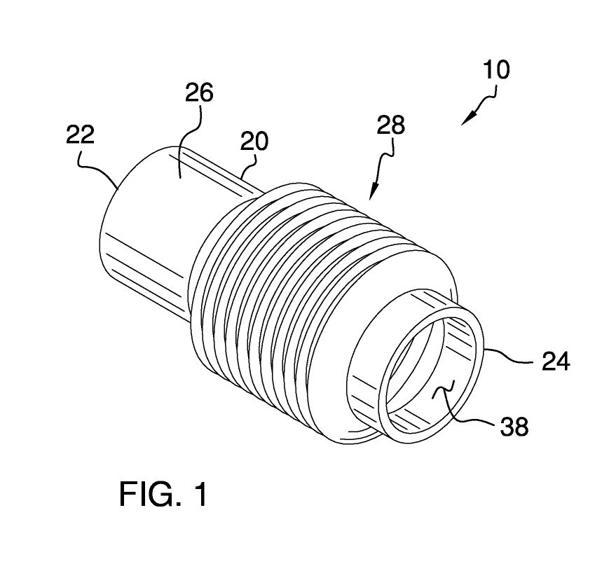

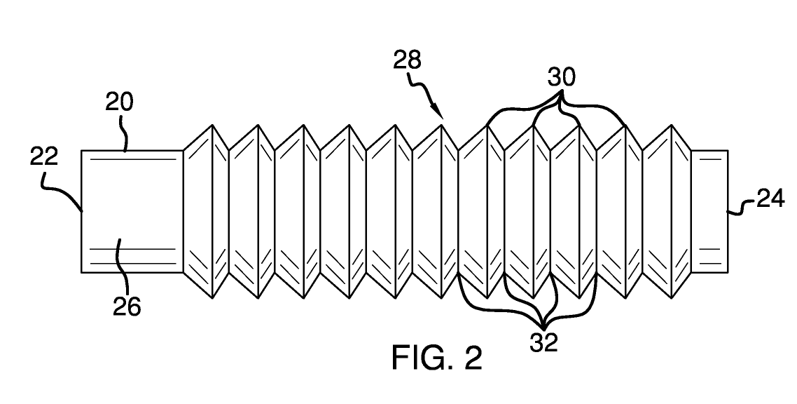

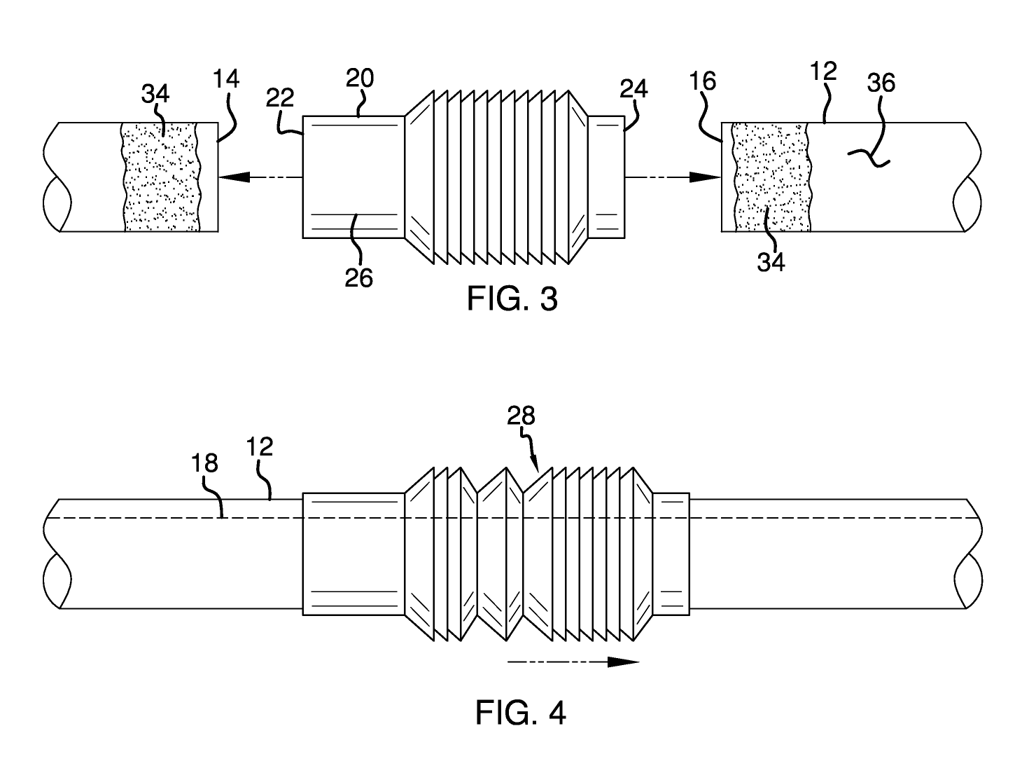

With reference now to the drawings, and in particular to FIGS. 1 through 4 thereof, a new pipe repair device embodying the principles and concepts of an embodiment of the disclosure and generally designated by the reference numeral 10 will be described.

As best illustrated in FIGS. 1 through 4, the pipe repair system 10 generally comprises a pipe 12 that is broken to define a first end 14 of the pipe 12 and a second end 16 of the pipe 12. The pipe 12 transfers a fluid 18. The pipe 12 may comprise a low pressure sprinkler pipe or the like that is buried beneath ground and the fluid 18 may be water. Additionally, the pipe 12 may be comprised of polyvinyl chloride.

A tube 20 is provided that has a primary end 22, a secondary end 24 and a peripheral wall 26 extending therebetween. The primary end 22 insertably receives the first end 14 and the secondary end 24 insertably receives the second end 16 such that the tube 20 extends across the break in the pipe 12. The tube 20 fluidly joins the first end 14 to the second end 16 to prevent the fluid 18 from escaping the pipe 12. The tube 20 may be comprised of polyvinyl chloride and may have a length ranging between 5 cm and 15 cm and a diameter ranging between 12 mm and 20 mm.

The peripheral wall 26 has a pleated section 28. The pleated section 28 is positioned between the primary end 22 and the secondary end 24 and comprises an alternating sequence of peaks 30 and valleys 32. The pleated section 28 is compressible or expandable to alter a length of the tube 20 and accommodate a variety of lengths of breaks in the pipe 12. An adhesive 34 is applied to an outer surface 36 of the pipe 12 adjacent to the first 14 and second 16 ends and an inner surface 38 of the tube 20 adjacent to the primary 22 and secondary 24 ends. The adhesive 34 creates a fluid impermeable bond between the pipe 12 and the tube 20. The adhesive 34 may comprise a polyvinyl chloride adhesive of any conventional composition.

In use, the tube 20 is utilized to repair the pipe 12 when the pipe 12 ruptures or is otherwise damaged. The adhesive 34 is applied to the pipe 12 and the tube 20. The first end 14 is inserted into the primary end 22. The length of the tube 20 is altered until the second end 16 is inserted into the secondary end 24. The tube 20 facilitates the pipe 12 to be repaired without the need to cut a splice to fit a length of the break in the pipe 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. (canceled)

3. (canceled)

4. A pipe repair system configured to repair a broken pipe, said system comprising:
a pipe being broken to define a first end of said pipe and a second end of said pipe, said pipe being configured to transfer a fluid;
a tube having a primary end, a secondary end and a peripheral wall extending therebetween, said primary end insertably receiving said first end and said secondary end insertably receiving said second end such that said tube extends across the break in said pipe and fluidly joins said first end to said second end, said tube being configured to prevent the fluid from escaping said pipe, said peripheral wall having a pleated section, said pleated section being positioned between said primary end and said secondary end, said pleated section comprising an alternating sequence of peaks and valleys, said pleated section being compressible or expandable to alter a length of said tube and accommodating a variety of lengths of breaks in said pipe, a distance along said tube between said primary end and said pleated section being greater than a distance along said tube between said secondary end and said pleated section; and
an adhesive, said adhesive being applied on said pipe and said tube, said adhesive forming a fluid impermeable barrier between said pipe and said tube.
